(19) United States
(12) Patent Application Publication
(10) Pub. No.: US 2022/0388499 A1
(43) Pub. Date: Dec. 8, 2022

(54) AUTOMATED VALET PARKING SYSTEM AND METHOD OF CONTROLLING AUTOMATED VALET PARKING SYSTEM

(71) Applicant: TOYOTA JIDOSHA KABUSHIKI KAISHA, Toyota-shi Aichi-ken (JP)

(72) Inventors: Tatsuya Sugano, Susono-shi Shizuoka-ken (JP); Noriyuki Tsuruoka, Susono-shi Shizuoka-ken (JP); Takanori Imazu, Susono-shi Shizuoka-ken (JP)

(73) Assignee: TOYOTA JIDOSHA KABUSHIKI KAISHA, Toyota-shi Aichi-ken (JP)

(21) Appl. No.: 17/713,802

(22) Filed: Apr. 5, 2022

(30) Foreign Application Priority Data
Jun. 2, 2021 (JP) 2021-092819

(51) Int. Cl. B60W 30/06; G06Q 50/30; G06Q 30/06

(52) U.S. Cl. CPC B60W 30/06; G06Q 50/30; G06Q 30/0645; B60W 2556/45

(57) ABSTRACT

In a parking area of a parking place, a plurality of parking spaces are aligned in a longitudinal direction and a lateral direction. An automated valet parking system acquires a vehicle attribute of an automated valet parking subject vehicle, sets a parking subarea that is at least part of the parking area in accordance with the vehicle attribute, based on the vehicle attribute, sets priorities of the parking spaces for parking the automated valet parking subject vehicle in the parking subarea, based on positional information on the parking spaces in the parking subarea, determines a target parking space that is the parking space serving as a target for parking the automated valet parking subject vehicle, based on vacancy information on the parking spaces in the parking subarea and the priorities, and causes the automated valet parking subject vehicle to be parked in the target parking space.

### CROSS-REFERENCE TO RELATED APPLICATION

This application claims priority to Japanese Patent Application No. 2021-092819 filed on Jun. 2, 2021, incorporated herein by reference in its entirety.

### BACKGROUND

### 1. Technical Field

The disclosure relates to an automated valet parking system and a method of controlling the automated valet parking system.

### 2. Description of Related Art

Conventionally, in automated valet parking that allows two or more self-driving vehicles to be parallel-parked, there is known an art of selecting a parking space and a parking position of a self-driving vehicle that is about to be loaded, based on parking space length information corresponding to lengths of respective parking spaces and total length sum information corresponding to the sum of total lengths of all the self-driving vehicles parked in the parking spaces respectively (e.g., Japanese Unexamined Patent Application Publication No. 2017-182230 (JP 2017-182230 A).

### SUMMARY

Recently, in this technical field, a parking method for sequentially parking vehicles from, for example, a parking space on the back side of a parking area without leaving any vacancy between the vehicles has been drawing attention, from the standpoint of efficiently utilizing parking spaces in the parking area. In this parking method, when an unload vehicle having a vehicle attribute corresponding to unload is unloaded, there is a need to temporarily evacuate vehicles having other vehicle attributes if these vehicles are parked in the direction in which the unload vehicle is unloaded (e.g., forward with respect to the vehicle). This interchange of the vehicles including the evacuation of vehicles having other vehicle attributes is time-consuming. Therefore, improvements need to be made to enhance the time efficiency of parking (loading and unloading) each of the vehicles.

In one aspect of the disclosure, there is provided an automated valet parking system in a parking place having a parking area in which a plurality of parking spaces are aligned in a longitudinal direction and a lateral direction. The automated valet parking system is equipped with a parking place administrative server for parking an automated valet parking subject vehicle in each of the parking spaces by issuing an instruction to a self-driving vehicle. The parking place administrative server is equipped with a vehicle attribute acquisition unit that acquires a vehicle attribute of the automated valet parking subject vehicle, a subarea setting unit that sets a parking subarea that is at least part of the parking area in accordance with the vehicle attribute, based on the vehicle attribute, a priority setting unit that sets priorities of the parking spaces for parking the automated valet parking subject vehicle in the parking subarea, based on positional information on the parking spaces in the parking subarea, a parking space determination unit that determines a target parking space that is the parking space serving as a target for parking the automated valet parking subject vehicle, based on vacancy information on the parking spaces in the parking subarea and the priorities, and a vehicle instruction unit that causes the automated valet parking subject vehicle to be parked in the target parking space.

With the automated valet parking system according to the aspect of the disclosure, the subarea setting unit sets the parking subarea in accordance with the vehicle attribute of the automated valet parking subject vehicle that has been acquired by the vehicle attribute acquisition unit, based on the vehicle attribute. The priority setting unit sets the priorities of the parking spaces for parking the automated valet parking subject vehicle in the parking subarea, based on the positional information on the parking spaces in the parking subarea. The parking space determination unit determines the target parking space based on the vacancy information on the parking spaces in the parking subarea and the priorities thereof. Thus, automated valet parking subject vehicles that are identical in vehicle attribute to one another are sequentially parked in the same parking subarea. As a result, for example, when an upload vehicle having a certain vehicle attribute is unloaded, the possibility of vehicles having other vehicle attributes being parked in the direction in which this unload vehicle is unloaded can be reduced. Accordingly, when the unload vehicle is unloaded from the parking area, the necessity to evacuate other vehicles that are different in vehicle attribute from the unload vehicle can be eliminated, and the time needed to interchange the vehicles can be reduced.

In one embodiment, the automated valet parking subject vehicle may be a shared vehicle that is rented out to users. The vehicle attribute acquisition unit may acquire a vehicle type and a vehicle class of the automated valet parking subject vehicle, as the vehicle attribute. The subarea setting unit may set parking subareas for vehicle types or vehicle classes of the automated valet parking subject vehicle respectively in such a manner that the parking subareas do not overlap with one another in the parking area. In this case, the necessity to evacuate other vehicles that are different in vehicle type or vehicle class from the unload vehicle can be eliminated.

In another embodiment, the automated valet parking subject vehicle may be a shared vehicle that is rented out to users. The vehicle attribute acquisition unit may acquire a first vehicle attribute including a vehicle type and a vehicle class of the automated valet parking subject vehicle, and a second vehicle attribute that does not include the vehicle type or vehicle class of the automated valet parking subject vehicle, as the vehicle attribute. The subarea setting unit may set a first subarea that is the parking subarea for the automated valet parking subject vehicle having the first vehicle attribute, and a second subarea that is the parking subarea for the automated valet parking subject vehicle having the second vehicle attribute, in such a manner that the first subarea and the second subarea do not overlap with each other in the parking area. The parking space determination unit may determine the target parking space for the automated valet parking subject vehicle having the second vehicle attribute, based on vacancy information on the parking spaces in the second subarea and the priorities of the parking spaces in the second subarea. In this case, when an unload vehicle having either the first vehicle attribute or the second vehicle attribute is unloaded, the evacuation of vehicles having the other vehicle attribute can be omitted.

In another aspect of the disclosure, there is provided a method of controlling an automated valet parking system in a parking place having a parking area in which a plurality of parking spaces are aligned in a longitudinal direction and a lateral direction. The automated valet parking system is equipped with a parking place administrative server for parking an automated valet parking subject vehicle in each of the parking spaces by issuing an instruction to a self-driving vehicle. The method includes a vehicle attribute acquisition step for acquiring a vehicle attribute of the automated valet parking subject vehicle, a subarea setting step for setting a parking subarea that is at least part of the parking area in accordance with the vehicle attribute, based on the vehicle attribute, a priority setting step for setting priorities of the parking spaces for parking the automated valet parking subject vehicle in the parking subarea, based on positional information on the parking spaces in the parking subarea, a parking space determination step for determining a target parking space that is the parking space serving as a target for parking the automated valet parking subject vehicle, based on vacancy information on the parking spaces in the parking subarea and the priorities, and a vehicle instruction step for causing the automated valet parking subject vehicle to be parked in the target parking space.

With the method of controlling the automated valet parking system according to the aspect of the disclosure, the parking subarea is set in accordance with the vehicle attribute of the automated valet parking subject vehicle that has been acquired in the vehicle attribute acquisition step, based on the vehicle attribute, in the subarea setting step. The priorities of the parking spaces for parking the automated valet parking subject vehicle in the parking subarea are set in the priority setting step, based on the positional information on the parking spaces in the parking subarea. The target parking space is determined in the parking space determination step, based on the vacancy information on the parking spaces in the parking subarea and the priorities thereof. Thus, automated valet parking subject vehicles that are identical in vehicle attribute to one another are sequentially parked in the same parking subarea. Therefore, for example, when an unload vehicle having the vehicle attribute is unloaded, the possibility of vehicles having other vehicle attributes being parked in the direction in which the unload vehicle is unloaded can be reduced. Accordingly, when the unload vehicle is unloaded from the parking area, the necessity to evacuate other vehicles that are different in vehicle attribute from the unload vehicle can be eliminated, and the time needed to interchange the vehicles can be reduced.

With the automated valet parking system and the method of controlling the automated valet parking system according to the disclosure, when the unload vehicle is unloaded from the parking area, the necessity to evacuate other vehicles that are different in vehicle attribute from the unload vehicle can be eliminated, and the time needed to interchange the vehicles can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a view for illustrating an automated valet parking system according to one of the embodiments;

FIG. 2 is a block diagram showing an example of the hardware configuration of a parking place administrative server;

FIG. 3 is a block diagram showing an example of the functional configuration of the parking place administrative server;

FIG. 4 is a view showing an example of parking subareas;

FIG. 5 is a view showing an example of a target parking space in FIG. 4;

FIG. 6 is a view showing another example of parking subareas;

FIG. 7 is a view showing an example of a target parking space in FIG. 6;

FIG. 8 is a view showing still another example of a parking subarea;

FIG. 9 is a view showing an example of a target parking space in FIG. 8;

FIG. 10 is a block diagram showing an example of a self-driving vehicle;

FIG. 11 is a flowchart showing an example of a loading process;

FIG. 12 is a flowchart showing an example of a subarea setting process of FIG. 11;

FIG. 13 is a flowchart showing an example of a priority setting process of FIG. 11;

FIG. 14 is a flowchart showing an example of a parking space determination process of FIG. 11; and

FIG. 15 is a view showing a modification example of the parking subareas of FIG. 4.

### DETAILED DESCRIPTION OF EMBODIMENTS

The embodiments of the disclosure will be described hereinafter with reference to the drawings.

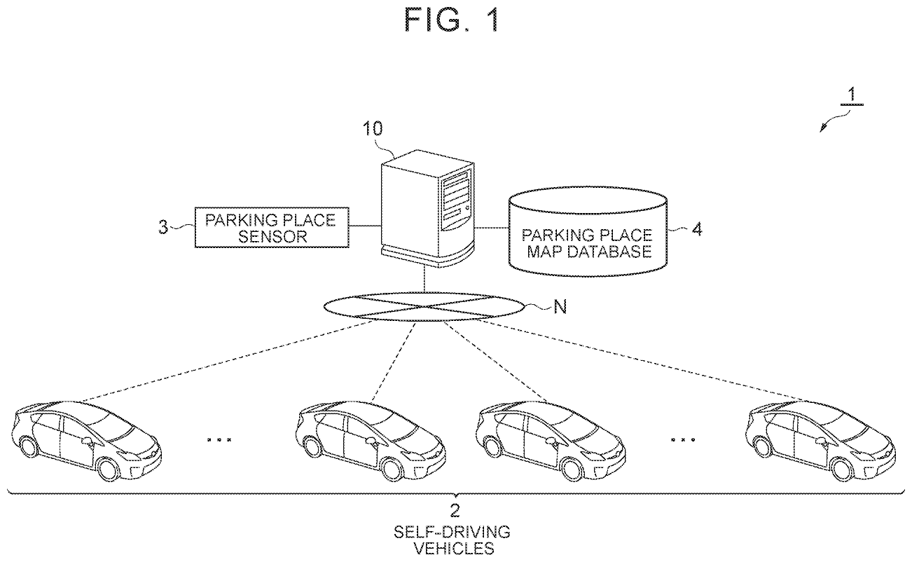

FIG. 1 is a view for illustrating an automated valet parking system according to one of the embodiments. An automated valet parking system (AVPS) 1 shown in FIG. 1 is a system for carrying out automated valet parking in a parking place.

Automated valet parking is a service of automatically parking an unmanned vehicle (an automated valet parking subject vehicle) that has been left by a user (a passenger) at a spot for getting off in a parking place in a target parking space in the parking place in accordance with an instruction from the parking place side. The target parking space is a parking space serving as a target for parking the automated valet parking subject vehicle. The automated valet parking subject vehicle is a vehicle that is a subject of automated valet parking by the automated valet parking system 1. The automated valet parking subject vehicle includes, for example, a shared vehicle that is rented out to users. As the shared vehicle, it is possible to mention a vehicle for business purposes such as a vehicle for rental services including hiring and car sharing, an official vehicle, a vehicle for company use, a commercial vehicle, and the like. For each of these vehicle types, a certain number of vehicles are available. The automated valet parking subject vehicle may include a privately owned vehicle that is possessed and used by an individual. The expression “privately owned” means possession resulting from the purchase by an individual, possession resulting from a lease to an individual, or the like. The user of the privately owned vehicle may not necessarily be the owner of the vehicle.

Automated valet parking includes a first mode in which a self-driving vehicle 2 automatically runs along a target route in a self-propelled manner in accordance with an instruction from the parking place side and is automatically parked in a target parking space in a self-propelled manner. The target route is a route in the parking place along which the self-driving vehicle 2 runs to reach the target parking space. In the first mode, the self-driving vehicle 2 itself is an automated valet parking subject vehicle. In the present embodiment, the following description will be given based on an example of automated valet parking of the self-driving vehicle in the first mode.

In automated valet parking, automated running and automated valet parking of the self-driving vehicle 2 are carried out. Automated running is vehicle control for causing the self-driving vehicle 2 to run toward the target parking space along the target route on a running path in the parking place. Automated valet parking is vehicle control for parking the self-driving vehicle 2 in the target parking space.

After parking the self-driving vehicle 2, the automated valet parking system 1 unloads the self-driving vehicle 2 that is parked, in accordance with a pickup request from a passenger. The automated valet parking system 1 causes the self-driving vehicle 2 to be unloaded to automatically run toward the target parking space for boarding set within a parking frame (a waiting frame) of a boarding spot, and automatically parks the self-driving vehicle 2 in the target parking space for boarding, so that the self-driving vehicle 2 waits until the passenger arrives.

Incidentally, the parking place may be a dedicated parking place for automated valet parking, or may also serve as a parking place for general vehicles to which automated valet parking is not applied. Part of the parking place for general vehicles may be used as a dedicated area for automated valet parking. It does not matter whether the parking place is an indoor parking place or an outdoor parking place.

The parking place has at least one parking area. In the parking area, a plurality of parking frames (parking spaces) are aligned in a longitudinal direction and a lateral direction. The longitudinal direction corresponds to a direction in which vehicles enter or leave the parking spaces in the parking area. The longitudinal direction corresponds to, for example, a long-side direction of the parking frames in the parking area. The lateral direction intersects with the direction in which vehicles enter or leave the parking spaces in the parking area. The lateral direction corresponds to, for example, a short-side direction of the parking frames in the parking area.

[Configuration of Automated Valet Parking System]

The configuration of the automated valet parking system 1 will be described hereinafter with reference to the drawings. As shown in FIG. 1, the automated valet parking system 1 is equipped with a parking place administrative server 10. The parking place administrative server 10 is a server for administering the parking place.

The parking place administrative server 10 is configured to be able to communicate with self-driving vehicles 2. The self-driving vehicles 2 will be described later in detail. The parking place administrative server 10 may be provided in the parking place, or in a facility distant from the parking place. The parking place administrative server 10 may be constituted of a plurality of computers provided at different locations respectively. The parking place administrative server 10 is connected to a parking place sensor 3 and a parking place map database 4.

The parking place sensor 3 is a sensor for recognizing a situation in the parking place. The parking place sensor 3 includes, for example, a monitoring camera for detecting positions of the self-driving vehicles 2 in the parking place. The monitoring camera is provided on a ceiling or wall of the parking place, and images the self-driving vehicles 2 in the parking place. The monitoring camera transmits images obtained through imaging to the parking place administrative server 10.

The parking place sensor 3 may include a vacancy sensor for detecting whether or not there are parked vehicles in the parking frames (whether the parking frames are occupied or vacant). The vacancy sensor may be provided for each of the parking frames. Alternatively, the single vacancy sensor may be provided on the ceiling or the like and configured to be able to monitor the parking frames. The configuration of the vacancy sensor is not limited in particular. The vacancy sensor can adopt any well-known configuration. The vacancy sensor may be a pressure sensor, a radar sensor or sonar sensor using electric waves, or a camera. The vacancy sensor transmits vacancy information in the parking frames to the parking place administrative server 10.

The parking place map database 4 is a database that stores parking place map information. The parking place map information includes positional information on the parking frames in the parking place, and information on running paths in the parking place. The parking place map information includes, for example, information on the longitudinal number that is the number of parking frames aligned in the longitudinal direction. The parking place map information may include information on the lateral number that is the number of parking frames aligned in the lateral direction. The parking place map information may include information on a parking service type (which will be described later) and vehicle attributes for each parking place. For example, the parking place map information on a parking place of which the parking service type is the keeping of shared vehicles (which will be described later) includes vehicle attributes of automated valet parking subject vehicles as shared vehicles. The parking place map information on a parking place of which the parking service type is the temporary placement of privately owned vehicles (which will be described later) may include vehicle attributes of automated valet parking subject vehicles as privately owned vehicles. Besides, the parking place map information may include positional information on landmarks for use in positional recognition by the self-driving vehicles 2. The landmarks include at least one of white lines, poles, safety cones, and pillars in the parking place.

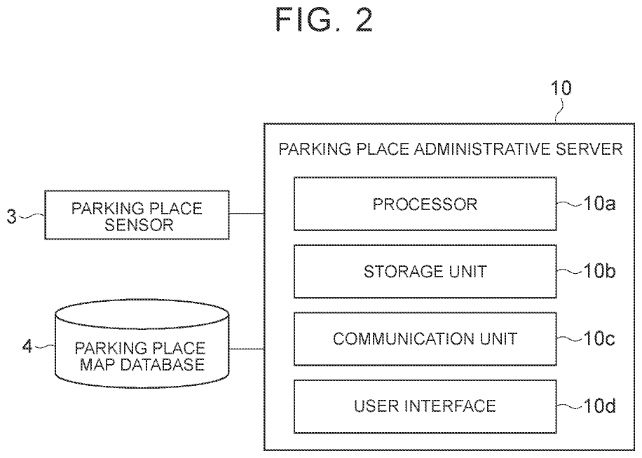

The hardware configuration of the parking place administrative server 10 will be described. FIG. 2 is a block diagram showing an example of the hardware configuration of the parking place administrative server. As shown in FIG. 2, the parking place administrative server 10 is configured as a general computer equipped with a processor 10a, a storage unit 10b, a communication unit 10c, and a user interface 10d.

The processor 10a actuates various operating systems to control the parking place administrative server 10. The processor 10a is a computing unit such as a central processing unit (CPU) including a control device, a computing device, a register, and the like. The processor 10a comprehensively controls the storage unit 10b, the communication unit 10c, and the user interface 10d. The storage unit 10b is, for example, a recording medium including at least one of a read-only memory (ROM), a random access memory (RAM), a hard disk drive (HDD), and a solid state drive (SSD).

The communication unit 10c is a communication device for wireless communication via a network N. A network device, a network controller, a network card, or the like can be used as the communication unit 10c. The parking place administrative server 10 communicates with the self-driving vehicles 2 through the use of the communication unit 10c. The user interface 10d is an input/output unit of the parking place administrative server 10 for an administrator of the parking place administrative server 10 or the like. The user interface 10d includes an output unit such as a display or a speaker, and an input unit such as a touch panel.

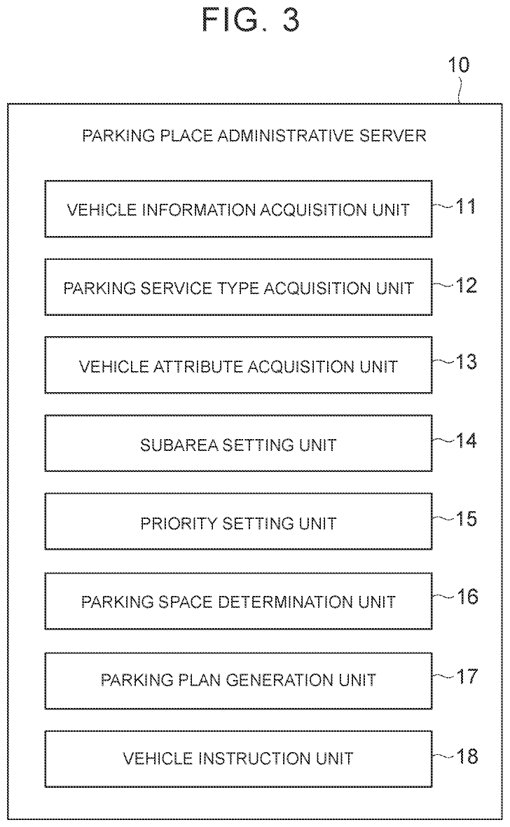

Next, the functional configuration of the parking place administrative server 10 will be described. FIG. 3 is a view showing an example of the functional configuration of the parking place administrative server. As shown in FIG. 3, the parking place administrative server 10 has a vehicle information acquisition unit 11, a parking service type acquisition unit 12, a vehicle attribute acquisition unit 13, a subarea setting unit 14, a priority setting unit 15, a parking space determination unit 16, a parking plan generation unit 17, and a vehicle instruction unit 18.

The vehicle information acquisition unit 11 acquires vehicle information on the self-driving vehicles 2 through communication with the self-driving vehicles 2 in the parking place. The vehicle information includes identification information on the self-driving vehicles 2 and positional information on the self-driving vehicles 2 in the parking place. The identification information is only required to be information that allows each of the self-driving vehicles 2 to be specified. The identification information may be an identification (ID) number, a vehicle number, a reservation number of automated valet parking, or the like.

The vehicle information may include the vehicle number in addition to the identification information. The vehicle information may include loading reservation information such as a loading reservation time, and may include an unloading scheduled time. The vehicle information may include vehicle body information such as the turning radius, size, vehicle width, and the like of the self-driving vehicles 2, and may include information on the self-driving function of the self-driving vehicles 2. The information on the self-driving function may include version information on the self-driving function.

The vehicle information may include the running state of the self-driving vehicles 2 and the recognition result of an external environment. The running state and the recognition of the external environment will be described later. The vehicle information may include information on the remaining travelable distance of the self-driving vehicles 2 or the amount of remaining fuel in the self-driving vehicles 2. The vehicle information may include whether the self-driving vehicles 2 are in an automated running mode or an automated valet parking mode.

The vehicle information acquisition unit 11 continuously acquires the vehicle information from the self-driving vehicles 2 during automated valet parking. The vehicle information acquisition unit 11 may stop acquiring the vehicle information when the self-driving vehicles 2 are parked, or may acquire the vehicle information on a regular basis.

The vehicle information acquisition unit 11 recognizes the situation of the self-driving vehicles 2 during automated valet parking, based on the acquired vehicle information. The situation of the self-driving vehicles 2 includes the positions of the self-driving vehicles 2 in the parking place. The situation of the self-driving vehicles 2 may include the vehicle speeds of the self-driving vehicles 2, the yaw rates of the self-driving vehicles 2, and the distances between the self-driving vehicles 2 and other vehicles existing therearound.

The parking service type acquisition unit 12 acquires a parking service type based on parking place map information. The parking service type is the type of a parking service offered in a parking place to be administered by the parking place administrative server 10. The parking service type includes the type of a parking service for keeping shared vehicles through parking, and the type of a parking service for temporarily placing privately owned vehicles through parking. As the parking place offering the parking service for parking shared vehicles, it is possible to mention, for example, a parking place where vehicles for rental services such as hiring and car sharing are parked, and a parking place where company vehicles or commercial vehicles are parked. As the parking place offering the parking service for parking privately owned vehicles, it is possible to mention, for example, a parking place established as an adjunct facility of a large shopping mall. The parking service type acquisition unit 12 acquires whether the parking service type is designed to keep shared vehicles through parking or to temporarily place privately owned vehicles through parking, based on, for example, the parking place map information in the parking place map database 4 corresponding to the parking place administered by the parking place administrative server 10.

The vehicle attribute acquisition unit 13 acquires the vehicle attribute of an automated valet parking subject vehicle. The vehicle attribute acquisition unit 13 acquires the vehicle attribute of the automated valet parking subject vehicle through, for example, communication with the self-driving vehicles 2 in the parking place. The vehicle attribute acquisition unit 13 acquires the vehicle attribute (a first vehicle attribute) including the vehicle type and vehicle class of the automated valet parking subject vehicle.

The vehicle attribute is information on classification of the automated valet parking subject vehicle that is used to determine the target parking space in the parking area. In the case where the automated valet parking subject vehicle is a shared vehicle, the vehicle attribute includes, for example, the vehicle type and vehicle class of the automated valet parking subject vehicle.

The vehicle type is equivalent to a classification according to the vehicle name of the automated valet parking subject vehicle. The vehicle class is equivalent to a classification according to the vehicle rank, features, or intended use of the automated valet parking subject vehicle. In the case of hiring and car sharing, as the vehicle class, it is possible to mention, for example, a compact car class, a standard class, a luxury (expensive car) class, an ecology class, an SUV class, and a commercial car class. As another example of the vehicle class, in the case of, for example, vehicles for business purposes, these vehicles may be classified into official vehicles or company vehicles for transporting senior officials, board members, or the like, and vehicles for sales and marketing at the customers' places. The vehicles for sales and marketing at the customers' places may further be classified into light vehicles, standard vehicles, and the like.

Moreover, in the case where the automated valet parking subject vehicle is a vehicle for rental services, the vehicle attribute may include a tariff class (e.g., economy class). Incidentally, in the case where the automated valet parking subject vehicle is a privately owned vehicle, the vehicle attribute may include whether or not the intended use of the automated valet parking subject vehicle is welfare. Welfare as the intended use may mean, for example, that the automated valet parking subject vehicle is a vehicle capable of accepting passengers in wheel chairs.

The vehicle attribute acquisition unit 13 may acquire a vehicle attribute (a second vehicle attribute) that does not include any vehicle type or vehicle class of the automated valet parking subject vehicle. As a concrete example, in the case where the automated valet parking subject vehicle is a shared vehicle for hiring and car sharing, it is possible to mention a vehicle classified into a minority category other than main vehicle types and main vehicle classes (e.g., “others”), as the automated valet parking subject vehicle having a vehicle attribute that does not include any vehicle type or vehicle class. In the case where the automated valet parking subject vehicle is a shared vehicle, it is possible to mention a communication vehicle that simply moves within the premises for business purposes, as the automated valet parking subject vehicle having a vehicle attribute that does not include any vehicle type or vehicle class. In the case where the automated valet parking subject vehicle is a privately owned vehicle, it is possible to mention, for example, a general private vehicle that is owned by an individual and not intended for welfare, as the automated valet parking subject vehicle having a vehicle attribute that does not include any vehicle type or vehicle class.

The subarea setting unit 14 sets a parking subarea in accordance with the vehicle attribute of the automated valet parking subject vehicle, based on the vehicle attribute. The parking subarea is at least part of the parking area, and an area that is set such that the positions where automated valet parking subject vehicles are parked in the parking area are divided into virtual regions corresponding to vehicle attributes respectively.

The subarea setting unit 14 may determine whether or not the parking service type is the keeping of shared vehicles. The subarea setting unit 14 determines, for example, whether the parking service type is the keeping of shared vehicles or the temporary placement of privately owned vehicles. The case where the parking service type is the temporary placement of privately owned vehicles will be described later.

When it is determined that the parking service type is the keeping of shared vehicles, the subarea setting unit 14 sets the parking subarea in accordance with the vehicle attribute of the automated valet parking subject vehicle, based on the vehicle attribute. The subarea setting unit 14 sets, for example, the parking subarea for each vehicle type or vehicle class of the automated valet parking subject vehicle.

When it is determined that the parking service type is the keeping of shared vehicles, the subarea setting unit 14 may further determine whether or not the vehicle attribute of the automated valet parking subject vehicle parked in the parking area includes the vehicle type and vehicle class of the automated valet parking subject vehicle (determine whether or not the vehicle attribute of the automated valet parking subject vehicle is the first vehicle attribute), based on the parking place map information. When it is determined that the vehicle attribute is the first vehicle attribute, the subarea setting unit 14 may set a first subarea that is a parking subarea for the automated valet parking subject vehicle having the first vehicle attribute. When it is determined that the vehicle attribute is the first attribute, the subarea setting unit 14 sets a parking subarea for each vehicle type or vehicle class of the automated valet parking subject vehicle. When it is determined that the vehicle attribute is not the first vehicle attribute, the subarea setting unit 14 may determine that the vehicle attribute is the second vehicle attribute, and may set a second subarea that is a parking subarea for the automated valet parking subject vehicle having the second vehicle attribute.

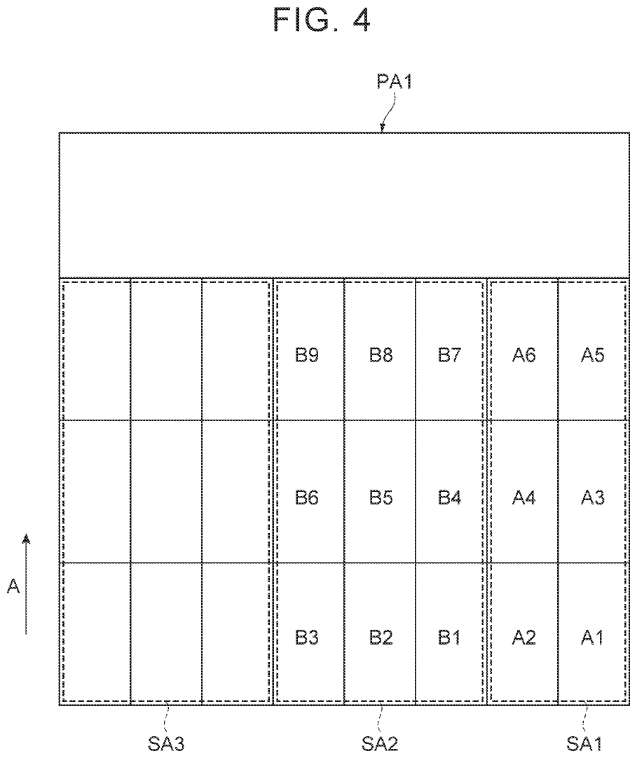

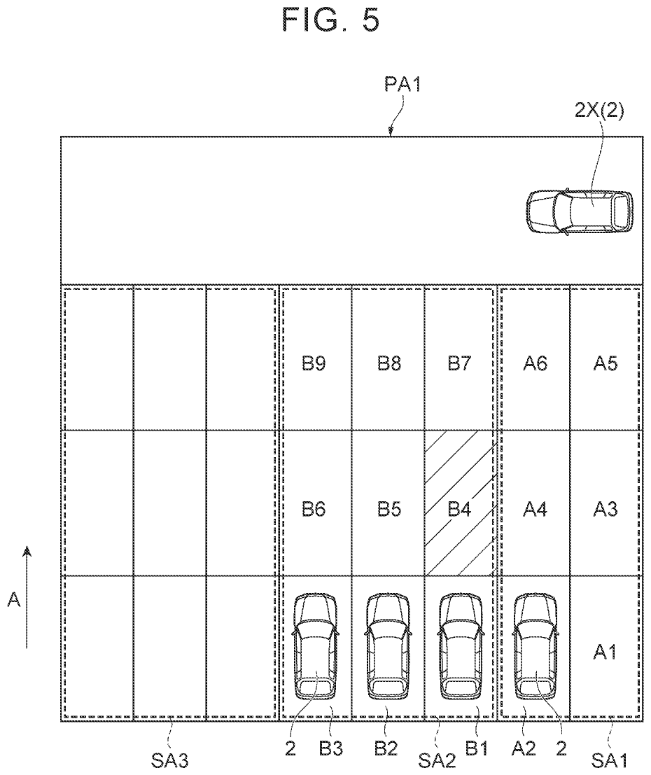

FIG. 4 is a view showing an example of parking subareas. FIG. 5 is a view showing an example of the target parking space in FIG. 4. FIGS. 4 and 5 show a parking area PA1 including parking subareas SA1, SA2, and SA3. In the parking area PA1, the longitudinal direction is indicated by an arrow A in the drawings. In the parking area PA1, a plurality of parking frames are aligned in the longitudinal direction and in the lateral direction. In the parking area PA1, there are three rows of parking frames in the longitudinal direction, and each of these rows is made up of eight parking frames that are aligned in the lateral direction.

As shown in FIG. 5, as an example, the self-driving vehicles 2 are parked in the parking area PA1, with the forward direction with respect to these vehicles indicated by the arrow A. The self-driving vehicles 2 make an entrance while moving backward from the side indicated by the arrow A toward the other side (the back side), and are sequentially parked from the back side without leaving any vacancy therebetween. This parking method may also be referred to as “cram parking”. Incidentally, this parking method only requires the self-driving vehicles 2 to be parked sequentially from the back side with no vacancy left therebetween, so the self-driving vehicles 2 may make an entrance while moving forward from the side indicated by the arrow A toward the back side. Incidentally, the other side of the back side in the longitudinal direction of the parking area will be referred to as an entrance region side. The entrance region means a region that is entered by the self-driving vehicles 2 in the parking area.

In the example of FIG. 4, the self-driving vehicles (the automated valet parking subject vehicles) 2 are vehicles for rental services, for example, hiring, and the parking service type of the parking area PA1 is the keeping of shared vehicles. It is assumed herein that the self-driving vehicles 2 belonging to the compact car class as a vehicle class, the self-driving vehicles 2 belonging to the standard class as a vehicle class, and the self-driving vehicles 2 having a vehicle attribute that does not include any vehicle type or vehicle class are kept in the parking area PAL

In the example of FIG. 4, as for each of the self-driving vehicles 2 of which the vehicle class is the compact car class, the subarea setting unit 14 determines that the parking service type is the keeping of shared vehicles, and that the vehicle attribute is the first vehicle attribute. The subarea setting unit 14 sets the parking subarea SA1 that is the first subarea, as to each of the self-driving vehicles 2 of which the vehicle class is the compact car class. By the same token, the subarea setting unit 14 determines that the parking service type is the keeping of shared vehicles, and that the vehicle attribute is the first vehicle attribute, as to each of the self-driving vehicles 2 of which the vehicle class is the standard class. The subarea setting unit 14 sets the parking subarea SA2 that is the first subarea, as to each of the self-driving vehicles 2 of which the vehicle class is the standard class. The parking subareas SA1 and SA2 do not overlap with each other in the parking area PA1. That is, as shown in FIG. 4, when it is determined that the parking service type is the keeping of shared vehicles, the subarea setting unit 14 sets the parking subareas SA1 and SA2 corresponding to the vehicle types or vehicle classes of the self-driving vehicles 2 respectively, in such a manner that the parking subareas SA1 and SA2 do not overlap with each other in the parking area PA1.

On the other hand, the subarea setting unit 14 determines that the parking service type is the keeping of shared vehicles, and that the vehicle attribute is the second vehicle type, as to each of the self-driving vehicles 2 having a vehicle attribute that does not include any vehicle type or vehicle class. The subarea setting unit 14 sets the parking subarea SA3 that is the second subarea, as to each of the self-driving vehicles 2 having a vehicle attribute that does not include any vehicle type or vehicle class. In the example of FIG. 4, the parking subarea SA3 that is the second subarea corresponds to a region obtained by removing the parking subareas SA1 and SA2 that are the first subarea from the entirety of the parking area PA1.

The priority setting unit 15 sets priorities of parking spaces, based on positional information on the parking spaces in each of the parking subareas. In a certain parking area, the priority of a parking space represents a position (a target parking space) where the self-driving vehicle 2 (the automated valet parking subject vehicle) is parked on a priority basis in a parking subarea set in the parking area. The parking space determination unit 16, which will be described later, uses the priorities of the parking spaces to determine the target parking space.

The priority setting unit 15 sequentially sets the priorities from the back side of the parking subarea toward the entrance region side. For example, the priority setting unit 15 sets the priorities of the parking spaces provided in the lateral direction sequentially along the lateral direction, and sets the priorities sequentially from a side far from the entrance region of the parking area toward the entrance region. That is, the priority setting unit 15 sets the priorities of the parking spaces along the lateral direction first as to a back-side row in the longitudinal direction of the parking place. After setting the priorities of all the parking spaces in this row, the priority setting unit 15 sets the priorities of the parking spaces along the lateral direction as to a next row (the row adjacent to the entrance region side).

More specifically, the priority setting unit 15 sets the priorities of the parking spaces such that the priorities on the back side of the parking subarea become higher than the priorities on the entrance region side of the parking subarea, based on, for example, positional information on the parking spaces in the parking subarea, and longitudinal numbers and subject numbers N thereof. Each of the subject numbers N is a number indicating a subject row that is a row in the parking subarea for which priorities are to be set. For example, the subject number N corresponding to the farthest back row in the longitudinal direction of the parking place is 1, and the subject number N increases one by one from the back side toward the entrance region side. Incidentally, the subject number N is a figure that is assigned for form's sake, and hence may increase, for example, from the entrance region side toward the back side in the longitudinal direction of the parking place. In this case, the priority setting unit 15 may set the priorities in such a sequence that the subject number N decreases.

The priority setting unit 15 acquires the longitudinal number stored in advance in the parking place map information. In the case where the longitudinal numbers in the longitudinal direction in the parking area are identical as to a plurality of rows adjacent to one another in the lateral direction (the parking areas are rectangular) as shown in, for example, FIG. 4, the priority setting unit 15 acquires the number of parking frames aligned in the longitudinal direction in each of the parking areas, as the longitudinal number.

As a concrete example, as shown in FIG. 4, the priority setting unit 15 acquires the longitudinal number as 3, and resets the subject number N by setting the subject number N to 1, as to the parking subarea SAL The priority setting unit 15 sequentially sets the parking spaces as A1 and A2 along the lateral direction, in the farthest back row where the subject number N is 1, as to the parking subarea SAL The priority setting unit 15 sequentially sets the parking spaces as A3 and A4 along the lateral direction, in the second row from the back where the subject number N is 2, as to the parking subarea SAL The priority setting unit 15 sequentially sets the parking spaces as A5 and A6 along the lateral direction, in the third row from the back where the subject number N is 3, as to the parking subarea SA1. After having finished setting the parking spaces in the row where the subject number N is equal to the longitudinal number, the priority setting unit 15 finishes setting the priorities.

By the same token, the priority setting unit 15 sequentially sets the parking spaces as B1, B2, and B3 along the lateral direction in the farthest back row where the subject number N is 1, as to the parking subarea SA2. The priority setting unit 15 sequentially sets the parking spaces as B4, B5, and B6 along the lateral direction in the second row from the back where the subject number N is 2, as to the parking subarea SA2. The priority setting unit 15 sequentially sets the parking spaces as B7, B8, and B9 along the lateral direction in the third row from the back where the subject number N is 3, as to the parking subarea SA2. After finishing setting the parking spaces in the row where the subject number N is equal to the longitudinal number, the priority setting unit 15 finishes setting the priorities. Incidentally, the priority setting unit 15 may set the priorities as to the parking subarea SA3 as well, in the same manner as in the case of the parking subarea SA1 or SA2.

The parking space determination unit 16 determines a target parking space that is a parking space serving as a target for parking an automated valet parking subject vehicle, based on vacancy information on the parking spaces in the parking subarea and the priorities of the parking spaces. The parking space determination unit 16 acquires the vacancy information on the parking spaces in each of the subareas, based on, for example, vacancy information on the parking frames in the parking place recognized from a detection result of the parking place sensor 3. The parking space determination unit 16 determines the parking space having the highest priority among vacant parking spaces, as the target parking space, in the parking subarea corresponding to the vehicle attribute of the self-driving vehicles 2 that are loaded. The parking space determination unit 16 may determine target parking spaces that are parking spaces serving as targets for parking the automated valet parking subject vehicles having the first vehicle attribute and the second vehicle attribute, based on vacancy information on the parking spaces and the priorities thereof in the first parking subarea and the second parking subarea respectively. The parking space determination unit 16 may determine a target parking space based on vacancy information on the parking spaces and the priorities thereof in the first parking subarea, in the first parking subarea corresponding to the vehicle type or vehicle class of the automated valet parking subject vehicle that is loaded.

In concrete terms, in the example of FIG. 5, when it is assumed that the vehicle attribute of a self-driving vehicle 2X that is loaded is the standard class as the vehicle class, the parking space determination unit 16 specifies the parking subarea SA2 as a subarea corresponding to the vehicle attribute of the self-driving vehicle 2X. As indicated by a hatched parking space in FIG. 5, the parking space determination unit 16 determines the parking space having the highest priority (the priority B4) among the vacant parking spaces (the priorities B4 to B9), as the target parking space, in the parking subarea SA2.

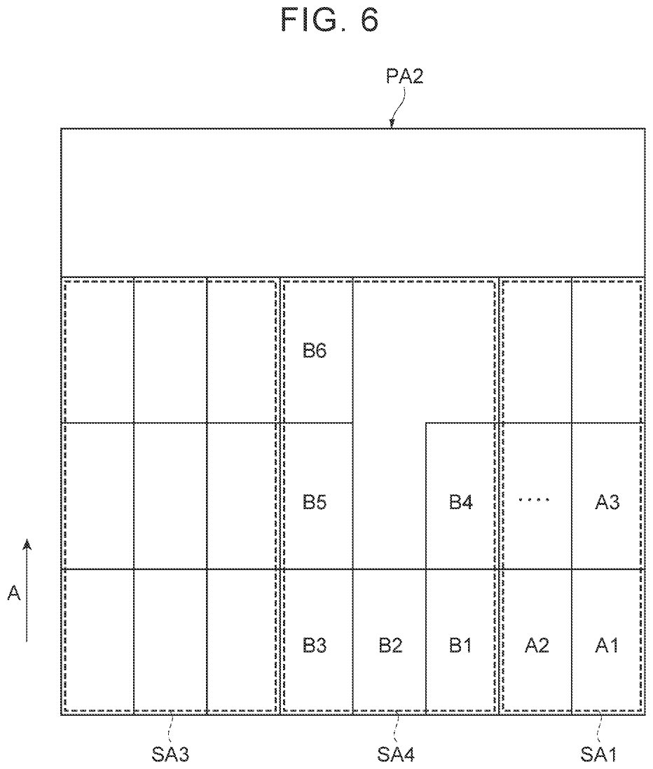

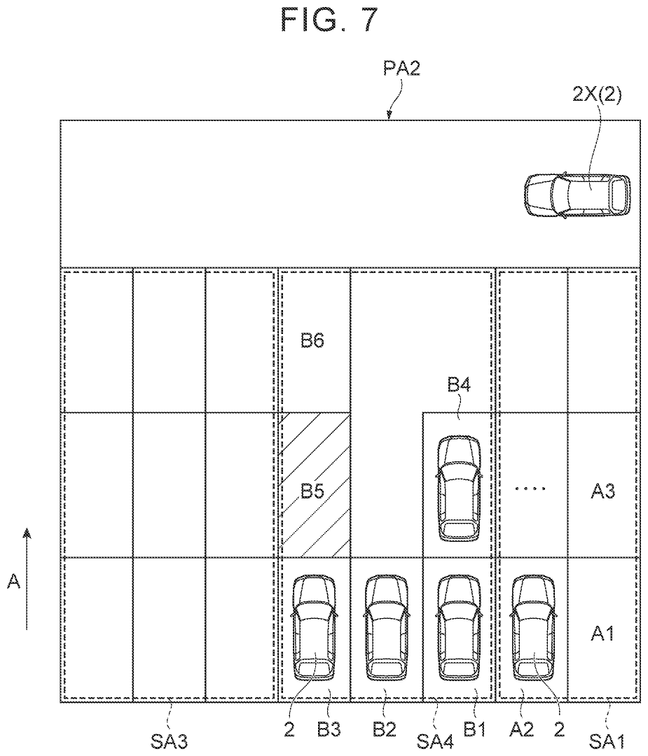

It should be noted herein that the arrangement of the parking frames in the parking area is not limited to the examples of FIGS. 4 and 5. FIG. 6 is a view showing another example of parking subareas. FIG. 7 is a view showing an example of a target parking space in FIG. 6. In FIGS. 6 and 7, a parking subarea SA4 having a different number of parking frames is depicted instead of the parking subarea SA2 in FIGS. 4 and 5. In the parking subarea SA4 in the parking area PA2, the longitudinal number in the longitudinal direction partially differs as to the rows that are adjacent to one another in the lateral direction. In the parking subarea SA4, some of the parking frames within the rectangle are omitted.

In the example of FIG. 6, the priority setting unit 15 may acquire the largest number of parking frames in the longitudinal direction, namely, 3, as the longitudinal number in the parking subarea SA4. The priority setting unit 15 resets the subject number N by setting the subject number N to 1, as to the parking subarea SA4. The priority setting unit 15 sequentially sets the parking spaces as B1, B2, and B3 along the lateral direction, in the farthest back row where the subject number N is 1, as to the parking subarea SA4. The priority setting unit 15 may sequentially set the parking spaces as B4 and B5 along the lateral direction in the second row from the back where the subject number N is 2, as to the parking subarea SA4. The priority setting unit 15 may set the parking space as B6 along the lateral direction, in the third row from the back where the subject number N is 3, as to the parking subarea SA4.

In the example of FIG. 7, when the vehicle attribute of the self-driving vehicle 2X that is loaded is assumed to be the standard class as the vehicle class, the parking space determination unit 16 specifies the parking subarea SA4 as a subarea corresponding to the vehicle attribute of the self-driving vehicle 2X. As indicated by a hatched parking space in FIG. 7, the parking space determination unit 16 determines the parking space having the highest priority (the priority B5) among the vacant parking spaces (the priorities B5 and B6), as the target parking space, in the parking subarea SA4.

By the way, when it is determined that the parking service type is the temporary placement of privately owned vehicles, the subarea setting unit 14 may set the parking subarea for privately owned vehicles as the entirety of the parking area. In this case, privately owned vehicles can be automatically parked in the entirety of the parking area, for example, a shopping mall.

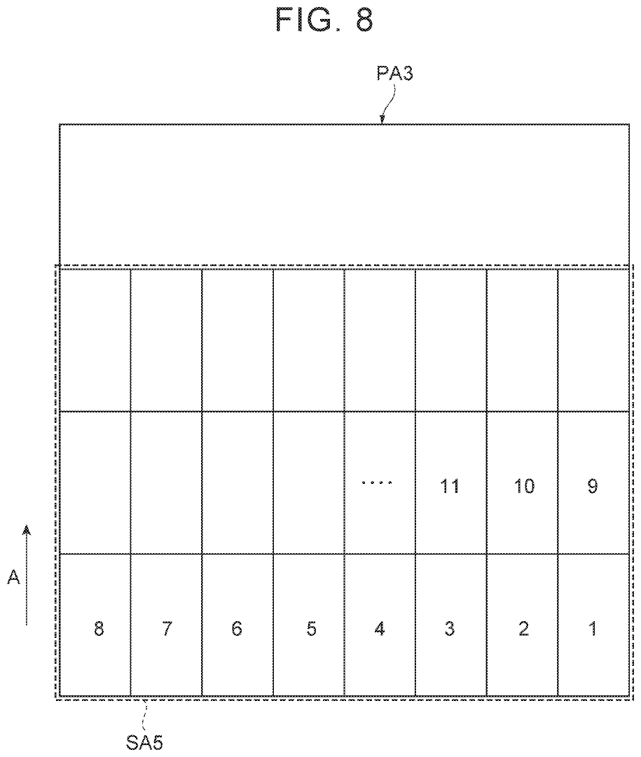

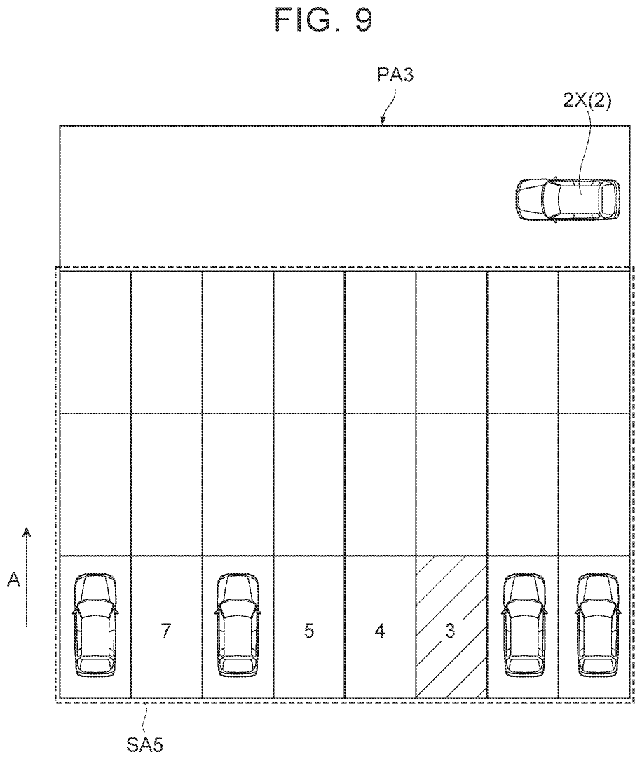

FIG. 8 is a view showing still another example of parking subareas. FIG. 9 is a view showing an example of a target parking space in FIG. 8. In FIGS. 8 and 9, a parking area PA3 including a parking subarea SA5 is depicted. The parking subarea SA5 is set as the entirety of the parking area PA3. The priority setting unit 15 acquires the longitudinal number as 3, and resets the subject number N by setting the subject number N to 1 as to the parking subarea SA3. The priority setting unit 15 may sequentially set parking spaces as 1, 2, 3, . . . , and 8 along the lateral direction in the farthest back row where the subject number N is 1, as to the parking subarea SA3. The priority setting unit 15 may sequentially set parking spaces as 9, 10, 11, . . . along the lateral direction, in the second row from the back where the subject number N is 2, as to the parking subarea SA3.

In the example of FIG. 9, the parking space determination unit 16 may specify the parking subarea SA5 as a subarea corresponding to the self-driving vehicle 2X that is loaded. As indicated by a hatched parking space in FIG. 9, the parking space determination unit 16 may determine the parking space having the highest priority (the priority 3) among the vacant parking spaces (the priorities 3, 4, 5, 7, . . . ) as the target parking space, in the parking subarea SA5.

The parking plan generation unit 17 generates a parking plan that is a running plan regarding the parking of the self-driving vehicles 2, based on the target parking space determined by the parking space determination unit 16, and the vehicle information acquired by the vehicle information acquisition unit 11. The parking plan includes the target parking space determined by the parking space determination unit 16, and a target route to the target parking space. Upon receiving a loading request from, for example, the self-driving vehicle 2 that has entered the parking place, the parking plan generation unit 17 starts generating a parking plan for parking the self-driving vehicle 2 in the target parking space determined by the parking space determination unit 16. The loading request may be made from a passenger's user terminal instead of being made from the self-driving vehicle 2.

The parking plan generation unit 17 sets the target route from the current position of the self-driving vehicle 2 toward the target parking space, based on positional information on the self-driving vehicle 2 acquired by the vehicle information acquisition unit 11, positional information on the target parking space determined by the parking space determination unit 16, and the parking place map information in the parking place map database 4.

The parking plan generation unit 17 sets the target route on the running path in the parking place. The target route may not necessarily be the shortest route. A route that does not interfere with or hardly interferes with target routes of other self-driving vehicles 2 may be selected on a priority basis. The method of setting the target route is not limited in particular, and it is possible to adopt various well-known methods.

Besides, the parking plan generation unit 17 may generate a vehicle speed plan for the self-driving vehicle 2. The parking plan generation unit 17 may compute target vehicle speeds for set positions set in advance on the target route (on the running path) respectively, and control the vehicle speed of the self-driving vehicle 2 by conveying the vehicle speed plan including positional information on the set positions and the target vehicle speeds. For example, the set positions are virtually set at certain intervals on the running path. The set positions may be set at intersections on the running path. The parking plan generation unit 17 may update the target vehicle speeds at the set positions in consideration of the running situation of other self-driving vehicles 2 and general vehicles.

Alternatively, the parking plan generation unit 17 may be designed to issue an appropriate instruction on the target vehicle speed as the position of the self-driving vehicle 2 changes, without generating any vehicle speed plan. The parking plan generation unit 17 may be designed to issue only an instruction on the upper limit of the vehicle speed to the self-driving vehicle 2 while allowing the self-driving vehicle 2 to adjust the vehicle speed thereof.

The vehicle instruction unit 18 issues an instruction to each of the self-driving vehicles 2 subjected to automated valet parking. The vehicle instruction unit 18 delivers the target route, target vehicle speeds, and the like for reaching the target parking space to the self-driving vehicle 2, in accordance with the parking plan generated by the parking plan generation unit 17, and controls the self-driving vehicle 2 such that the self-driving vehicle 2 (the automated valet parking subject vehicle) is parked in the target parking space.

In the automated valet parking system 1 configured as described above, for example, after one of the self-driving vehicles 2 is parked, the unloading of the self-driving vehicle 2 that is parked is carried out in response to a pickup request from a passenger. It should be noted herein that the self-driving vehicles 2 are sequentially parked from the back side without leaving any vacancy therebetween in, for example, the parking subarea SA2 in FIG. 5. In the example of FIG. 5, it is assumed that, for example, the self-driving vehicle 2 of which the vehicle class is the standard class is unloaded after the self-driving vehicle 2X is parked in the target parking space having the priority B4. If the vehicle attribute of the self-driving vehicle 2 located on the entrance region side is different from the vehicle attribute of the self-driving vehicle 2 located on the back side, there is a need to temporarily evacuate the self-driving vehicle 2 located on the entrance region side. In this respect, according to the present embodiment, the vehicle class of the self-driving vehicles 2 parked in the parking subarea SA2 is the standard class, and these vehicles have the same vehicle attribute. Therefore, instead of the self-driving vehicle 2 located on the back side (in the parking space having the priority B1), the self-driving vehicle 2 located on the entrance region side (in the parking space having the priority B4) can be unloaded. In this manner, when an unload vehicle of which the vehicle class is the standard class is unloaded from the parking area PA1, the necessity to evacuate other vehicles that are different in vehicle attribute from the unload vehicle and of which the vehicle class is the compact car class or “others” can be eliminated. As a result, the time needed to interchange the self-driving vehicles 2 can be reduced.

[Configuration of Self-Driving Vehicles]

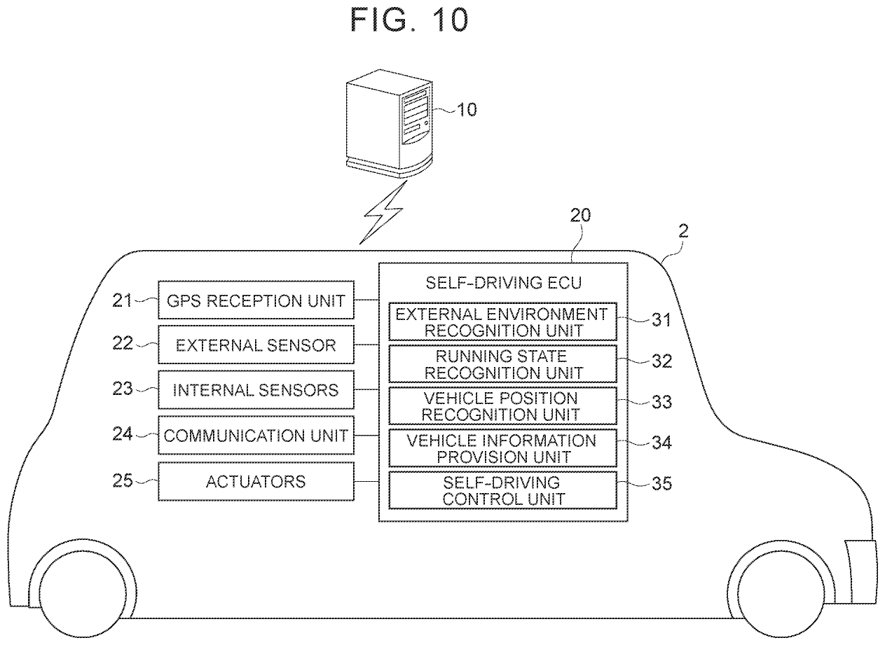

Subsequently, an example of the configuration of the self-driving vehicles 2 according to the present embodiment (the self-driving vehicles that receive an instruction on automated valet parking from the automated valet parking system 1) will be described. FIG. 10 is a block diagram showing an example of each of the self-driving vehicles 2. Incidentally, in the present embodiment, the self-driving vehicles 2 are not included in the automated valet parking system 1.

As shown in FIG. 10, each of the self-driving vehicles 2 has, for example, a self-driving ECU 20. The self-driving ECU 20 is an electronic control unit having a CPU, a ROM, a RAM, and the like. The self-driving ECU 20 realizes various functions by, for example, loading a program recorded in the ROM into the RAM and causing the CPU to execute the program loaded into the RAM. The self-driving ECU 20 may be constituted of a plurality of electronic units.

The self-driving ECU 20 is connected to a GPS reception unit 21, an external sensor 22, internal sensors 23, a communication unit 24, and actuators 25.

The GPS reception unit 21 measures a position of the self-driving vehicle 2 (e.g., the latitude and longitude of the self-driving vehicle 2) by receiving signals from a plurality of GPS satellites. The GPS reception unit 21 transmits the measured positional information on the self-driving vehicle 2 to the self-driving ECU 20. A global navigation satellite system (GNSS) reception unit may be used instead of the GPS reception unit 21.

The external sensor 22 is an in-vehicle sensor that detects an external environment of the self-driving vehicle 2. The external sensor 22 includes at least a camera. The camera is an imaging instrument that images the external environment of the self-driving vehicle 2. The camera is provided on, for example, the back side of a windshield of the self-driving vehicle 2. The camera transmits imaging information on the external environment of the self-driving vehicle 2 to the self-driving ECU 20. The camera may be a monocular camera or a stereo camera. A plurality of cameras may be provided to image areas to the right and left of the self-driving vehicle 2 and an area behind the self-driving vehicle 2 as well as an area in front of the self-driving vehicle 2.

The external sensor 22 may include a radar sensor. The radar sensor is a detecting instrument that detects objects around the self-driving vehicle 2 through the use of electric waves (e.g., millimeter waves) or light. The radar sensor includes, for example, a millimeter-wave radar or a light detection and ranging (LiDAR). The radar sensor transmits electric waves or light to the areas around the self-driving vehicle 2, and detects an object by receiving the electric waves or light reflected by the object. The radar sensor transmits information on the detected object to the self-driving ECU 20. Besides, the external sensor 22 may include a sonar sensor that detects the sound outside the self-driving vehicle 2.

The internal sensors 23 are in-vehicle sensors that detect a running state of the self-driving vehicle 2. The internal sensors 23 include a vehicle speed sensor, an acceleration sensor, and a yaw rate sensor. The vehicle speed sensor is a detector that detects a speed of the self-driving vehicle 2. Each of wheel speed sensors provided on wheels of the self-driving vehicles 2 or on a drive shaft rotating integrally with the wheels or the like to detect rotational speeds of the wheels can be used as the vehicle speed sensor. The vehicle speed sensor transmits the detected vehicle speed information (wheel speed information) to the self-driving ECU 20.

The acceleration sensor is a detector that detects an acceleration of the self-driving vehicle 2. The acceleration sensor includes, for example, a longitudinal acceleration sensor that detects an acceleration in the longitudinal direction of the self-driving vehicle 2. The acceleration sensor may include a lateral acceleration sensor that detects a lateral acceleration of the self-driving vehicle 2. The acceleration sensor transmits, for example, acceleration information on the self-driving vehicle 2 to the self-driving ECU 20. The yaw rate sensor is a detector that detects a yaw rate (rotational angular velocity) of the center of gravity of the self-driving vehicle 2 around a vertical axis thereof. For example, a gyro sensor can be used as the yaw rate sensor. The yaw rate sensor transmits information on the detected yaw rate of the self-driving vehicle 2 to the self-driving ECU 20.

The communication unit 24 is a communication device that controls wireless communication with the outside of the self-driving vehicle 2. The communication unit 24 transmits and receives various pieces of information through communication with the parking place administrative server 10. For example, the communication unit 24 transmits vehicle information to the parking place administrative server 10, and acquires information required for automated valet parking (e.g., information on landmarks along the target route) from the parking place administrative server 10.

The actuators 25 are instruments used to control the self-driving vehicles 2. The actuators 25 include at least a drive actuator, a brake actuator, and a steering actuator. The drive actuator controls the amount of air supplied to an engine (e.g., a throttle opening degree) in accordance with a control signal from the self-driving ECU 20, and hence controls the driving force of the self-driving vehicle 2. Incidentally, in the case where the self-driving vehicle 2 is a hybrid electric vehicle, the driving force is controlled with the control signal from the self-driving ECU 20 input to a motor that serves as a motive power source, in addition to the amount of air supplied to the engine. In the case where the self-driving vehicle 2 is a battery electric vehicle, the driving force is controlled with the control signal from the self-driving ECU 20 input to a motor that serves as a motive power source. In each of these cases, the motor serving as the motive power source belongs to the actuators 25.

The brake actuator controls a brake system in accordance with a control signal from the self-driving ECU 20, and hence controls the braking force applied to the wheels of the self-driving vehicle 2. For example, a hydraulic brake system can be used as the brake system. The steering actuator controls the driving of an assist motor that controls the steering torque in an electric power steering system, in accordance with a control signal from the self-driving ECU 20. Thus, the steering actuator controls the steering torque of the self-driving vehicle 2.

Next, an example of the functional configuration of the self-driving ECU 20 will be described. The self-driving ECU 20 has an external environment recognition unit 31, a running state recognition unit 32, a vehicle position recognition unit 33, a vehicle information provision unit 34, and a self-driving control unit 35.

The external environment recognition unit 31 recognizes an external environment of the self-driving vehicle 2, based on a detection result of the external sensor 22 (an image imaged by the camera or object information detected by the radar sensor). The external environment includes the position of each of objects around the self-driving vehicle 2 relative to the self-driving vehicle 2. The external environment may include the speed and moving direction of each of the objects around the self-driving vehicle 2 relative to the self-driving vehicle 2. The external environment recognition unit 31 recognizes objects such as other vehicles and pillars of a parking place through pattern matching or the like. The external environment recognition unit 31 may recognize gates of the parking place, walls of the parking place, poles, safety cones, and the like. Besides, the external environment recognition unit 31 may recognize dividing boundaries in the parking place by recognizing white lines.

The running state recognition unit 32 recognizes a running state of the self-driving vehicle 2, based on detection results of the internal sensors 23. The running state includes the vehicle speed of the self-driving vehicle 2, the acceleration of the self-driving vehicle 2, and the yaw rate of the self-driving vehicle 2. In concrete terms, the running state recognition unit 32 recognizes a vehicle speed of the self-driving vehicle 2, based on vehicle speed information obtained from the vehicle speed sensor. The running state recognition unit 32 recognizes an acceleration of the self-driving vehicle 2, based on acceleration information obtained from the acceleration sensor. The running state recognition unit 32 recognizes the orientation of the self-driving vehicle 2, based on yaw rate information obtained from the yaw rate sensor.

The vehicle position recognition unit 33 recognizes a position of the self-driving vehicle 2 in the parking place, based on parking place map information acquired from the parking place administrative server 10 through the communication unit 24, and the external environment recognized by the external environment recognition unit 31.

The vehicle position recognition unit 33 recognizes the position of the self-driving vehicle 2 in the parking place, based on positional information on landmarks in the parking place included in the parking place map information, and positions of the landmarks relative to the self-driving vehicle 2 that have been recognized by the external environment recognition unit 31. Objects fixedly provided in the parking place can be used as the landmarks.

In addition, the vehicle position recognition unit 33 may recognize the position of the self-driving vehicle 2 through dead reckoning, based on detection results of the internal sensors 23. Besides, the vehicle position recognition unit 33 may recognize the position of the self-driving vehicle 2 through communication with beacons provided in the parking place.

The vehicle information provision unit 34 provides the parking place administrative server 10 with vehicle information through the communication unit 24. The vehicle information provision unit 34 provides the parking place administrative server 10 with vehicle information including information on the position of the self-driving vehicle 2 in the parking place that has been recognized by the vehicle position recognition unit 33, for example, at intervals of a certain time. The vehicle information may include the external situation recognized by the self-driving vehicle 2 and/or the running state of the self-driving vehicle 2.

The self-driving control unit 35 performs the self-driving of the self-driving vehicle 2. The self-driving control unit 35 generates a trajectory of the self-driving vehicle 2, based on, for example, the target route, the position of the self-driving vehicle 2, the external environment of the self-driving vehicle 2, and the running state of the self-driving vehicle 2. The trajectory corresponds to the running plan of self-driving. The trajectory includes a path along which the vehicle runs through self-driving, and a vehicle speed plan in self-driving.

The path is a locus along which the vehicle is scheduled to run during self-driving on the target route designated by the automated valet parking system. The path may be, for example, data on changes in the steering angle (a steering angle plan) of the self-driving vehicle 2 corresponding to positions on the target route. The positions on the target route are, for example, set longitudinal positions set at intervals of a predetermined distance (e.g., 1 m) in a traveling direction along the target route. The steering angle plan is data with which a target steering angle is associated for each of the set longitudinal positions. The self-driving control unit 35 generates the trajectory, for example, such that the vehicle passes the center of the running path in the parking place along the target route.

When the parking plan generation unit 17 of the parking place administrative server 10 designates a parking plan (a target parking space and a target route) for the self-driving control unit 35, the self-driving control unit 35 performs self-driving in accordance with the parking plan. In the case where the parking plan does not include any steering angle plan or vehicle speed plan corresponding to positions, the self-driving control unit 35 generates a steering angle plan and a vehicle speed plan on the self-driving vehicle 2 side to realize automated running.

When the self-driving vehicle 2 arrives near the target parking space, the self-driving control unit 35 stops the self-driving vehicle 2 and waits for an instruction from the parking place administrative server 10. The self-driving control unit 35 may notify the parking place administrative server 10 of the arrival of the self-driving vehicle 2 near the target parking space.

Alternatively, the self-driving control unit 35 may notify the parking place administrative server 10 of the start of automated valet parking in the target parking space (a changeover from an automated running mode to an automated valet parking mode), based on an automated valet parking start condition set in advance. The automated valet parking start condition may be a condition for performing automated valet parking in the target parking space. The automated valet parking start condition may be, for example, that the self-driving vehicle 2 has been stopped within a certain distance from the target parking space, or that the external sensor 22 of the self-driving vehicle 2 has succeeded in appropriately recognizing the target parking space.

[Method of Controlling Automated Valet Parking System]

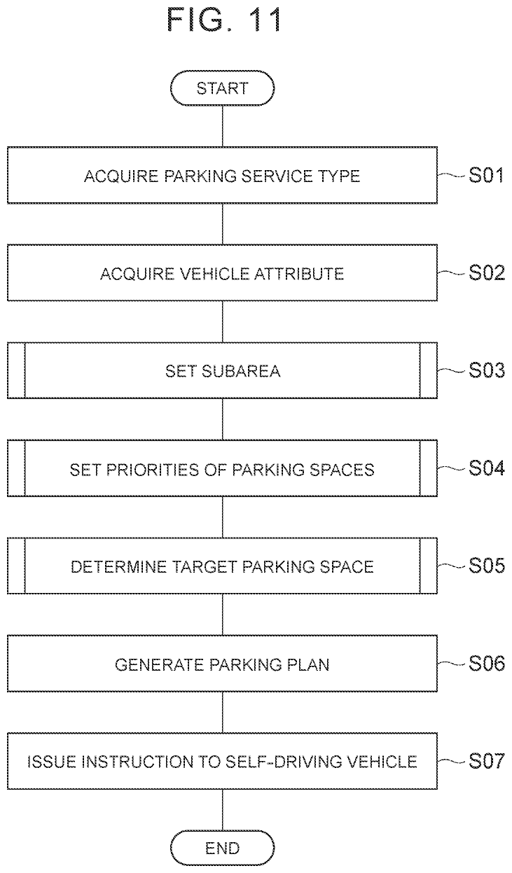

Next, an example of the method of controlling the automated valet parking system 1 (the process performed by the parking place administrative server 10) according to the present embodiment will be described. FIG. 11 is a flowchart showing an example of a loading process. The loading process is performed, for example, upon the start of automated valet parking for loading each of the self-driving vehicles 2 in response to a request therefrom.

As shown in FIG. 11, the parking place administrative server 10 of the automated valet parking system 1 acquires a parking service type through the parking service type acquisition unit 12 as S01 (a parking service type acquisition step). The parking service type acquisition unit 12 acquires whether the parking service type is the keeping of shared vehicles through parking or the temporary placement of privately owned vehicles through parking, based on, for example, parking place map information in the parking place map database 4 corresponding to a parking place administered by the parking place administrative server 10.

In S02, the parking place administrative server 10 acquires a vehicle attribute through the vehicle attribute acquisition unit 13 (a vehicle attribute acquisition step). The vehicle attribute acquisition unit 13 acquires a vehicle attribute of an automated valet parking subject vehicle through, for example, communication with the self-driving vehicles 2 in the parking place.

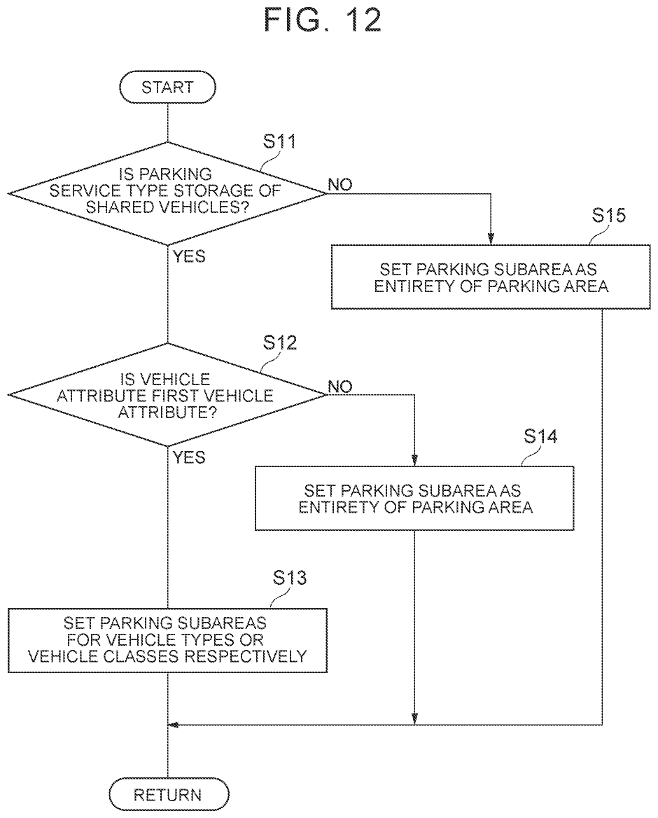

In S03, the parking place administrative server 10 sets a subarea through the subarea setting unit 14 (a subarea setting step). In concrete terms, the parking place administrative server 10 performs the process of FIG. 12 as an example of the processing of S03. FIG. 12 is a flowchart showing an example of the subarea setting process of FIG. 11.

As shown in FIG. 12, the parking place administrative server 10 determines through the subarea setting unit 14 whether or not the parking service type is the keeping of shared vehicles as S11 (a parking service type specification step). If the subarea setting unit 14 determines that the parking service type is the keeping of shared vehicles (YES in S11), the parking place administrative server 10 shifts to the processing of S12. If the subarea setting unit 14 does not determine that the parking service type is the keeping of shared vehicles (NO in S11), the parking place administrative server 10 shifts to the processing of S15.

In S12, the parking place administrative server 10 determines through the subarea setting unit 14 whether or not the vehicle attribute is the first vehicle attribute (a vehicle attribute specification step). If the subarea setting unit 14 determines that the vehicle attribute is the first vehicle attribute (YES in S12), the parking place administrative server 10 shifts to the processing of S13. If the subarea setting unit 14 does not determine that the vehicle attribute is the first vehicle attribute (NO in S12), the parking place administrative server 10 shifts to the processing of S14.

In S13, the parking place administrative server 10 sets a parking subarea for each vehicle type or each vehicle class, through the subarea setting unit 14. After that, the parking place administrative server 10 ends the current process of FIG. 12, and returns to FIG. 11 to perform the processing of S04.

In S14, the parking place administrative server 10 sets the parking subarea as the entirety of the parking area through the subarea setting unit 14. After that, the parking place administrative server 10 ends the current process of FIG. 12, and returns to FIG. 11 to perform the processing of S04.

In S15, the parking place administrative server 10 sets the parking subarea as the entirety of the parking area through the subarea setting unit 14. After that, the parking place administrative server 10 ends the current process of FIG. 12, and returns to FIG. 11 to perform the processing of S04.

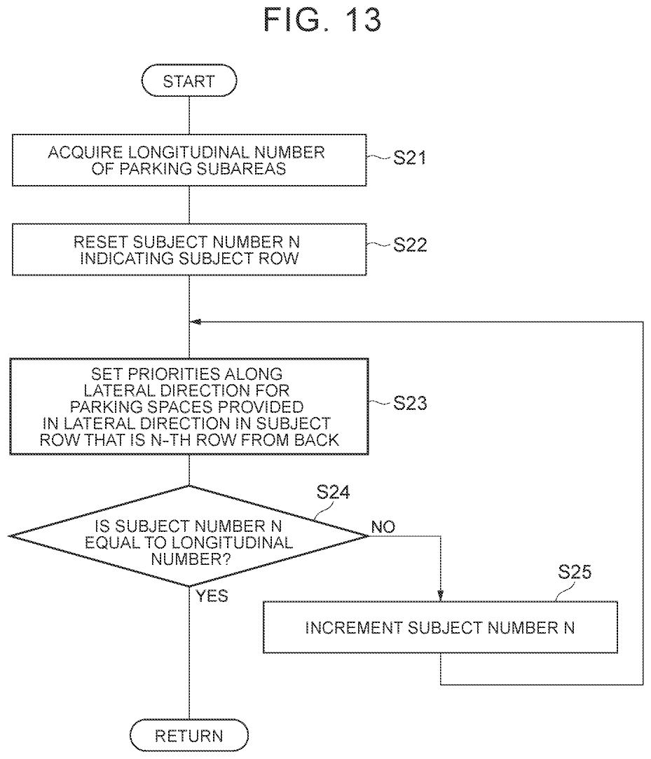

In S04 of FIG. 11, the parking place administrative server 10 sets priorities of the parking spaces through the priority setting unit 15 (a priority setting step). In concrete terms, the parking place administrative server 10 performs the process of FIG. 13, as an example of the processing of S04. FIG. 13 is a flowchart showing an example of the priority setting process of FIG. 11.

As shown in FIG. 13, the parking place administrative server 10 acquires the longitudinal number of parking subareas through the priority setting unit 15, as S21. The priority setting unit 15 acquires, for example, the longitudinal number stored in advance in the parking place map information.

In S22, the parking place administrative server 10 resets the subject number N indicating a subject row, through the priority setting unit 15. The priority setting unit 15 resets the subject number N by, for example, setting the subject number N to 1.

In S23, the parking place administrative server 10 sets the priorities along the lateral direction for the parking spaces provided in the lateral direction in the N-th subject row from the back, through the priority setting unit 15. In the case where, for example, N is 1, the priority setting unit 15 sets the priorities (e.g., A1, A2, B1, B2, B3, and the like) along the lateral direction, for the parking spaces in the first subject row from the back, as shown in FIGS. 4, 6, and 8.

In S24, the parking place administrative server 10 determines whether or not the subject number N is equal to the longitudinal number, through the priority setting unit 15. If the priority setting unit 15 does not determine that the subject number N is equal to the longitudinal number (NO in S24), the parking place administrative server 10 shifts to the processing of S25. In S25, the parking place administrative server 10 increments the subject number N through the priority setting unit 15. The priority setting unit 15 increments the subject number N by, for example, adding 1 to the subject number N. After that, the parking place administrative server 10 shifts to the processing of S23, and repeatedly sets the priorities as to the incremented subject number N, until the subject number N becomes equal to the longitudinal number.

On the other hand, if the priority setting unit 15 determines that the subject number N is equal to the longitudinal number (YES in S24), the parking place administrative server 10 ends the current process of FIG. 13, and returns to FIG. 11 to perform the processing of S05.

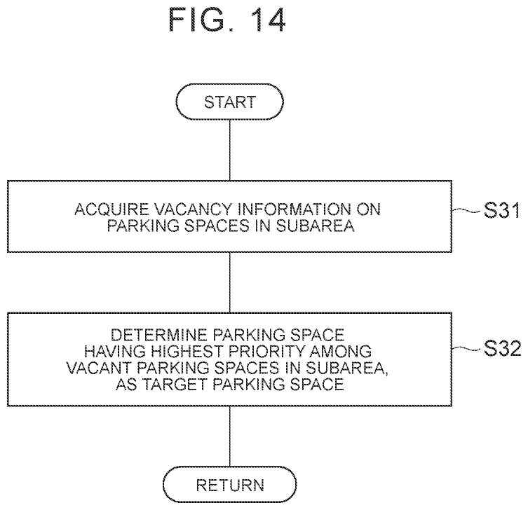

In S05 of FIG. 11, the parking place administrative server 10 determines a target parking space through the parking space determination unit 16 (a parking space determination step). In concrete terms, the parking place administrative server 10 performs the process of FIG. 14 as an example of the processing of S05. FIG. 14 is a flowchart showing an example of the parking space determination process of FIG. 11.

As shown in FIG. 14, the parking place administrative server 10 acquires vacancy information on the parking spaces in the subarea through the parking space determination unit 16, as S31. The parking space determination unit 16 acquires the vacancy information on the parking spaces in the subarea based on, for example, a vacancy situation of the parking frames in the parking place recognized from a detection result of the parking place sensor 3.

In S32, the parking place administrative server 10 determines the parking space having the highest priority among the vacant parking spaces in the subarea, as the target parking space, through the parking space determination unit 16. As indicated by, for example, the hatched parking space of FIG. 5, 7, or 9, the parking space determination unit 16 specifies the subarea corresponding to the vehicle attribute of the automated valet parking subject vehicle (SA2 of FIG. 5, SA4 of FIG. 7, or SA5 of FIG. 9). The parking space determination unit 16 determines, for example, the parking space having the highest priority among the vacant parking spaces in the specified subarea (B4 of FIG. 5, B5 of FIG. 7, or 3 of FIG. 9). After that, the parking place administrative server 10 ends the current process of FIG. 14, and returns to FIG. 11 to perform the processing of S06.

In S06, the parking place administrative server 10 generates a parking plan through the parking plan generation unit 17 (a parking plan generation step). The parking plan generation unit 17 generates a parking plan that is a running plan regarding the parking of the self-driving vehicle 2, based on the target parking space determined by the parking space determination unit 16 and the vehicle information acquired by the vehicle information acquisition unit 11.

In S07, the parking place administrative server 10 issues an instruction to the self-driving vehicle 2 through the vehicle instruction unit 18 (a vehicle instruction step). The vehicle instruction unit 18 delivers a target route, a target vehicle speed, and the like for enabling the self-driving vehicle 2 to reach the target parking space to the self-driving vehicle 2, in accordance with the parking plan generated by the parking plan generation unit 17. Thus, the vehicle instruction unit 18 parks the self-driving vehicle 2 (the automated valet parking subject vehicle) in the target parking space determined by the parking space determination unit 16. After that, the parking place administrative server 10 ends the process of FIG. 11.

According to the automated valet parking system 1 described above, the subarea setting unit 14 sets the parking subarea in accordance with the vehicle attribute of each of the self-driving vehicles 2 (the automated valet parking subject vehicle) acquired by the vehicle attribute acquisition unit 13, based on the vehicle attribute. The priority setting unit 15 sets the priorities of the parking spaces for parking each of the self-driving vehicles 2 in the parking subarea, based on positional information on the parking spaces in the parking subarea. The parking space determination unit 16 determines the target parking space, based on vacancy information on the parking spaces in the parking subarea and the priorities thereof. Thus, the self-driving vehicles 2 of the same vehicle attribute are sequentially parked in the same parking subarea. In the example of FIG. 5, the self-driving vehicles 2 having the same vehicle attribute as that corresponding to the parking subarea SA1 are sequentially parked in the parking subarea SAL The self-driving vehicles 2 having the same vehicle attribute as that corresponding to the parking subarea SA2 are sequentially parked in the parking subarea SA2. As a result, for example, when an unload vehicle having a certain vehicle attribute is unloaded, the possibility of vehicles having other vehicle attributes being parked in the direction in which this unload vehicle is unloaded can be reduced. Accordingly, when the unload vehicle is unloaded from the parking area, the necessity to evacuate other vehicles that are different in vehicle attribute from the unload vehicle can be eliminated, and the time needed to interchange the vehicles can be reduced.

In the foregoing embodiment, each of the self-driving vehicles 2 is a shared vehicle that is rented out to users. The vehicle attribute acquisition unit 13 acquires the vehicle type and vehicle class of each of the self-driving vehicles 2 as the vehicle attribute. The subarea setting unit 14 sets the parking subareas for the vehicle types or vehicle classes of the self-driving vehicles 2 respectively such that the self-driving vehicles 2 overlap with each other. In the example of FIG. 4, the parking subareas SA1 and SA2 corresponding to the vehicle types or vehicle classes of the self-driving vehicles 2 respectively are set in such a manner as not to overlap with each other in the parking area PAL Thus, the possibility of other vehicles that are different in vehicle type or vehicle class from an unload vehicle being parked in the parking subarea corresponding to the vehicle type or vehicle class of the unload vehicle can be reduced. In consequence, when the unload vehicle is unloaded, in the case where the self-driving vehicle 2 that is identical in vehicle type or vehicle class to the unload vehicle is located on the other side of the back side (the entrance region side) in the longitudinal direction as well, the self-driving vehicle 2 on the entrance region side may be unloaded. Accordingly, the necessity to evacuate other vehicles that are different in vehicle type or vehicle class from the unload vehicle can be eliminated.

In the foregoing embodiment, each of the self-driving vehicles 2 is a shared vehicle that is rented out to users. The vehicle attribute acquisition unit 13 acquires the first vehicle attribute including the vehicle type and vehicle class of each of the self-driving vehicles 2, and the second vehicle attribute that does not include any vehicle type or vehicle class of each of the self-driving vehicles 2, as the vehicle attribute. The subarea setting unit 14 sets the first subarea that is a parking subarea for the self-driving vehicles 2 having the first vehicle attribute, and the second subarea that is a parking subarea for the self-driving vehicles 2 having the second vehicle attribute, in such a manner that the first subarea and the second subarea do not overlap with each other in the parking area. The parking space determination unit 16 determines the target parking space for each of the self-driving vehicles 2 having the second vehicle attribute, based on the vacancy information on the parking spaces in the second subarea and the priorities thereof. In the example of FIG. 4, each of the parking subareas SA1 and SA2 is the first subarea, and the parking subarea SA3 is the second subarea. The parking subareas SA1 and SA2 are set in such a manner as not to overlap with the parking subarea SA3 in the parking area PAL Thus, it is possible to ensure that any vehicle having the second vehicle attribute is not parked in the parking subareas SA1 and SA2. In consequence, when an unload vehicle having the first vehicle attribute and parked in the parking subarea SA1 or SA2 is unloaded, the interchange of vehicles including the evacuation of vehicles having the second vehicle attribute can be omitted. By the same token, it is possible to ensure that any vehicle having the first vehicle attribute is not parked in the parking subarea SA3. In consequence, when an unload vehicle having the second vehicle attribute and parked in the parking subarea SA3 is unloaded, the evacuation of vehicles having the first vehicle attribute can be omitted.

According to the method of controlling the automated valet parking system 1, the parking subarea is set in accordance with the vehicle attribute of each of the self-driving vehicles 2 (the automated valet parking subject vehicle) acquired in the vehicle attribute acquisition step, based on the vehicle attribute, in the subarea setting step. The priorities of the parking spaces for parking the self-driving vehicles 2 in the parking subarea are set based on the positional information on the parking spaces in the parking subarea, in the priority setting step. The target parking space is determined based on the vacancy information on the parking spaces in the parking subarea and the priorities thereof, in the parking space determination step. Thus, the self-driving vehicles 2 that are identical in vehicle attribute to one another are sequentially parked in the same parking subarea. In the example of FIG. 5, the self-driving vehicles 2 having the same vehicle attribute as that corresponding to the parking subarea SA1 are sequentially parked in the parking subarea SAL The self-driving vehicles 2 having the same vehicle attribute as that corresponding to the parking subarea SA2 are sequentially parked in the parking subarea SA2. Therefore, for example, when an unload vehicle having a certain vehicle attribute is unloaded, the possibility of vehicles having other vehicle attributes being parked in the direction in which this unload vehicle is unloaded can be reduced. Accordingly, when the unload vehicle is unloaded from the parking area, the necessity to evacuate other vehicles that are different in vehicle attribute from the unload vehicle can be eliminated, and the time needed to interchange the vehicles can be reduced.

Although the embodiment of the disclosure has been described above, the disclosure should not be limited to the foregoing embodiment. The disclosure can be carried out in a variety of modes subjected to various alterations and improvements based on the knowledge of those skilled in the art, as well as the foregoing embodiment.

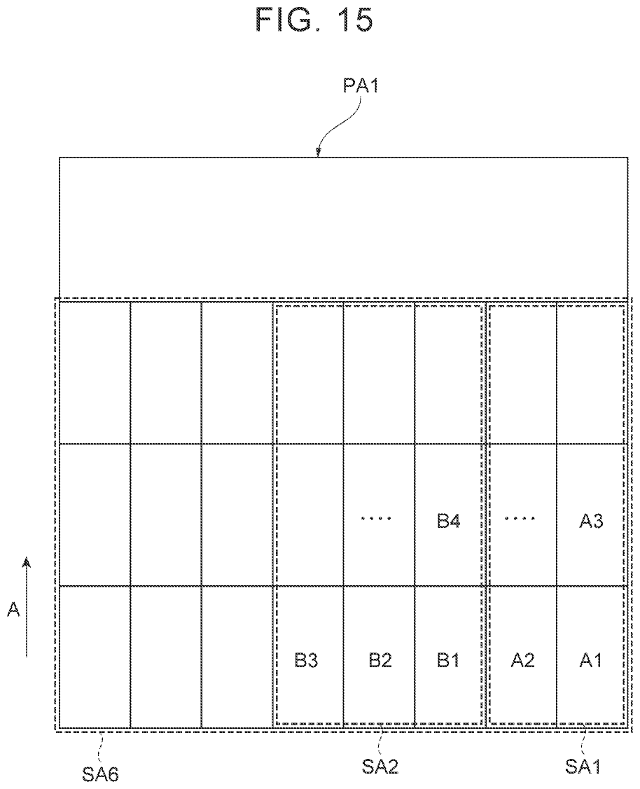

In the foregoing embodiment, in the example of FIG. 4, the parking subarea SA3 that is the second subarea corresponds to the region obtained by removing the parking subareas SA1 and SA2 as the first subarea from the entirety of the parking area PA1, but the disclosure is not limited thereto. For example, as shown in FIG. 15, the second subarea may be set as a parking subarea SA6 equivalent to the entirety of the parking area PAL In this case, for example, it is possible to adopt a flexible operation for renting the parking frames in the parking subareas SA1 and SA2 as a result of a temporary increase in the number of self-driving vehicles 2 having the second vehicle attribute in the case where, for example, the self-driving vehicle 2 that belongs to another base for renting cars and of which the vehicle attribute corresponds to “others” is dropped off in the parking area PAL

In the foregoing embodiment, in the example of FIG. 4, the parking subareas SA1 and SA2 are set in such a manner as not to overlap with the parking subarea SA3 in the parking area PA1, but the parking subareas SA1 and SA2 may overlap with each other. In this case, for example, it is possible to adopt a flexible operation for renting the parking frames in the parking subarea SA2 for the standard class as a result of a temporary increase in the number of self-driving vehicles 2 of the compact car class, in the case where, for example, the self-driving vehicle 2 of the compact car class that belongs to another base for renting cars is dropped off in the parking area PA1.

In the foregoing embodiment, in the example of FIG. 4, the subarea setting unit 14 sets the regions of the parking subareas SA1 and SA2 based on the parking place map information. However, as in the case where, for example, the aforementioned flexible operation is adopted, the regions of the parking subareas may be variably set based on the vehicle attributes of the self-driving vehicles 2, the number of self-driving vehicles 2 that are loaded and that have a certain vehicle attribute, and the like.

In the foregoing embodiment, in the example of FIG. 4, the subarea setting unit 14 sets the parking subareas for the automated valet parking subject vehicles as to both the first vehicle attribute and the second vehicle attribute. However, the subarea setting unit 14 may set the parking subareas for the automated valet parking subject vehicles as to one of the first vehicle attribute and the second vehicle attribute.

In the foregoing embodiment, the longitudinal number and the lateral number may not necessarily be included in the parking place map information. In this case, the longitudinal number and the lateral number may be acquired based on, for example, a detection result of the parking place sensor 3 or the like.

In the foregoing embodiment, the example of automated valet parking of the self-driving vehicles in the first mode, that is, the example in which each of the self-driving vehicles automatically runs in a self-propelled manner along the target route in accordance with an instruction from the parking place side and is automatically parked in a self-propelled manner in the target parking space has been described, but the disclosure is not limited to this example. That is, it is not indispensable to cause each of the automated valet parking subject vehicles itself to run in a self-propelled manner through self-driving. More specifically, automated valet parking for the self-driving vehicles may include a second mode in which automated valet parking is realized such that each of the automated valet parking subject vehicles is transported to a target parking space and parked through the control of a transportation robot having the self-driving function of the self-driving vehicles 2 by the parking place administrative server 10 in such a manner that the transportation robot transports each of the automated valet parking subject vehicles through self-driving. In the second mode, each of the automated valet parking subject vehicles is a vehicle other than the self-driving vehicles 2. That is, each of the self-driving vehicles 2 may include a transportation robot configured to be able to perform self-driving control through the parking place administrative server 10 and to be able to transport each of the automated valet parking subject vehicles. In this case, the automated valet parking subject vehicle may not have the self-driving function of the self-driving vehicle 2. This transportation robot can be equipped with, for example, a lift mechanism capable of lifting and holding the automated valet parking subject vehicle.

In automated valet parking of the second mode, automated running and automated valet parking of the transportation robot as each of the self-driving vehicles 2 are carried out. In automated running of the second mode, for example, the transportation robot as the self-driving vehicle 2 is caused to run on the running path of the parking place along the target route toward the target parking space, while holding the automated valet parking subject vehicle. In automated valet parking of the second mode, the transportation robot as the self-driving vehicle 2 parks the automated valet parking subject vehicle that has been held, in the target parking space.

In the second mode, the vehicle information may include a vehicle type of the automated valet parking subject vehicle, and may include a vehicle number in addition to identification information. The vehicle information may include loading reservation information such as a loading reservation time for the automated valet parking subject vehicle or the like, and may include an unloading scheduled time. In the second mode, the vehicle information acquisition unit 11 is not absolutely required to continuously acquire vehicle information from the automated valet parking subject vehicle during automated valet parking. The vehicle information acquisition unit 11 may acquire vehicle information from the automated valet parking subject vehicle in starting automated valet parking, and store and use this vehicle information. In the second mode, the parking plan generation unit 17 may generate a parking plan that is a running plan regarding automated running and automated valet parking of the self-driving vehicles 2, for the transportation robot for parking the automated valet parking subject vehicle, based on the target parking space determined by the parking space determination unit 16 and the vehicle information acquired by the vehicle information acquisition unit 11.

What is claimed is:

1. An automated valet parking system in a parking place having a parking area in which a plurality of parking spaces are aligned in a longitudinal direction and a lateral direction, the automated valet parking system comprising:
a parking place administrative server for parking an automated valet parking subject vehicle in each of the parking spaces by issuing an instruction to a self-driving vehicle, wherein
the parking place administrative server is equipped with
a vehicle attribute acquisition unit that acquires a vehicle attribute of the automated valet parking subject vehicle,
a subarea setting unit that sets a parking subarea that is at least part of the parking area in accordance with the vehicle attribute, based on the vehicle attribute,
a priority setting unit that sets priorities of the parking spaces for parking the automated valet parking subject vehicle in the parking subarea, based on positional information on the parking spaces in the parking subarea,
a parking space determination unit that determines a target parking space that is the parking space serving as a target for parking the automated valet parking subject vehicle, based on vacancy information on the parking spaces in the parking subarea and the priorities, and
a vehicle instruction unit that causes the automated valet parking subject vehicle to be parked in the target parking space.

2. The automated valet parking system according to claim 1, wherein
the automated valet parking subject vehicle is a shared vehicle that is rented out to users,
the vehicle attribute acquisition unit acquires a vehicle type and a vehicle class of the automated valet parking subject vehicle, as the vehicle attribute, and
the subarea setting unit sets parking subareas for vehicle types or vehicle classes of the automated valet parking subject vehicle respectively in such a manner that the parking subareas do not overlap with one another in the parking area.

3. The automated valet parking system according to claim 1, wherein
the automated valet parking subject vehicle is a shared vehicle that is rented out to users,
the vehicle attribute acquisition unit acquires a first vehicle attribute that includes a vehicle type and a vehicle class of the automated valet parking subject vehicle, and a second vehicle attribute that does not include the vehicle type or vehicle class of the automated valet parking subject vehicle, as the vehicle attribute,
the subarea setting unit sets a first subarea that is the parking subarea for the automated valet parking subject vehicle having the first vehicle attribute, and a second subarea that is the parking subarea for the automated valet parking subject vehicle having the second vehicle attribute, in such a manner that the first subarea and the second subarea do not overlap with each other in the parking area, and
the parking space determination unit determines the target parking space for the automated valet parking subject vehicle having the second vehicle attribute, based on vacancy information on the parking spaces in the second subarea and the priorities of the parking spaces in the second subarea.

4. A method of controlling an automated valet parking system in a parking place having a parking area in which a plurality of parking spaces are aligned in a longitudinal direction and a lateral direction, the automated valet parking system being equipped with a parking place administrative server for parking an automated valet parking subject vehicle in each of the parking spaces by issuing an instruction to a self-driving vehicle,
the method comprising:
a vehicle attribute acquisition step for acquiring a vehicle attribute of the automated valet parking subject vehicle;
a subarea setting step for setting a parking subarea that is at least part of the parking area in accordance with the vehicle attribute, based on the vehicle attribute;
a priority setting step for setting priorities of the parking spaces for parking the automated valet parking subject vehicle in the parking subarea, based on positional information on the parking spaces in the parking subarea;
a parking space determination step for determining a target parking space that is the parking space serving as a target for parking the automated valet parking subject vehicle, based on vacancy information on the parking spaces in the parking subarea and the priorities; and
a vehicle instruction step for causing the automated valet parking subject vehicle to be parked in the target parking space.
